(19) United States
(12) Patent Application Publication
(10) Pub. No.: US 2017/0161862 A1
(43) Pub. Date: Jun. 8, 2017

(54) METHOD AND ELECTRONIC DEVICE FOR ADDING WATERMARK TO VIDEO

(71) Applicants: Le Holdings(Beijing)Co., Ltd., Beijing (CN); LE SHI ZHI XIN ELECTRONIC TECHNOLOGY (TIAN JIN) LIMITED, Tianjin (CN)

(72) Inventor: Yunlong LI, Tianjin (CN)

(21) Appl. No.: 15/247,862

(22) Filed: Aug. 25, 2016

Related U.S. Application Data
(63) Continuation of application No. PCT/CN2016/088954, filed on Jul. 6, 2016.

(30) Foreign Application Priority Data
Dec. 4, 2015 (CN) 201510885409.0

(51) Int. Cl. G06T 1/00; H04N 19/136; H04N 19/167

(52) U.S. Cl. CPC G06T 1/0021; H04N 19/167; H04N 19/136; G06T 2201/005

(57) ABSTRACT

The embodiment of the present application relates to the field of videos, in particular to a method and electronic device for adding watermarks to a video. The method disclosed by this application comprises: determining multiple sub-regions; determining binary expected play time information of a target image and a digit in the binary expected play time information corresponding to each sub-region; and adjusting the specific parameter value of each sub-region so that a video display terminal determines the binary expected play time information of the target image according to the parity values of the specific parameter values of all sub-regions of the target image.

### CROSS REFERENCE TO RELATED APPLICATIONS

This application is a continuation of International Application No. PCT/CN2016/088954, filed on Jul. 6, 2016, which is based upon and claims priority to Chinese Patent Application No. 201510885409.0, field to the China Patent Office on Dec. 4, 2015 and entitled “Method and Equipment for Adding Watermark to Video and Determining Information of Watermark”, and the entire content of which is incorporated herein by reference.

### TECHNICAL FIELD

The disclosure relates to the technical field of videos, in particular to a method and electronic device for adding watermark to a video, storage medium.

### BACKGROUND

With the increase of network speed, more and more people watch online video programs, and online videos are mainly in a format of H.264. Network quality is subject to many conditions (such as weather, network load, etc.) and will significantly affect the watching of videos. Therefore, a server providing a video has to interact with equipment for watching the H.264 video continuously to carry out latency detection, so as to determine whether the video has latency or not, and improve the quality of network channels if latency happens.

During latency detection, a PTS (Present Time Stamp) of one frame of image functions as a key indicator. The PTS represents corresponding expected play time of one frame of image. The difference between the PTS of one frame of image and the actual play time of the frame of image is latency time of video playing, and the longer the latency time is, the more serious the latency degree is. Therefore, obtaining the PTS of one frame of image in a video is very important to determine whether the video has latency or not.

In the process of implementing the present invention, it is found by the inventor that the present method for obtaining the PTS of one frame of H.264 video in the video is implemented by coding the PTS of each frame of image in the video into the high frequency domain of a video file during the process of video coding and then decoding the PTS of each frame of video by video playing equipment through a special decoder. Therefore, a special decoder is needed to obtain the PTS of each frame of image in the prior art, which resulting in a disadvantage of poor universality.

### SUMMARY

The embodiment of the application provides a method and electronic device for adding watermark to a video, storage medium.

In the first aspect, the embodiment of this application provides a method for adding watermark to a video, including:

determining multiple sub-regions of watermark addition regions of all frames of images in the video;

determining binary expected play time information of a target image requiring watermark addition at present and a digit in the binary expected play time information corresponding to each sub-region, where the number of the sub-regions is not less than the number of digits in the binary expected play time information; and

adjusting the specific parameter value of each sub-region according to the binary expected play time information to make a parity value corresponding to the specific parameter value of each sub-region equal to the value of the digit of the binary expected play time information corresponding to the sub-region, so that a video display terminal determines the binary expected play time information of the target image according to the parity values corresponding to the specific parameter values of all sub-regions in the watermark addition regions of the target image.

In the second aspect, the embodiment of this application provides an electronic device, including:

at least one processor; and a memory communicably connected with the at least one processor for storing instructions executable by the at least one processor, wherein execution of the instructions by the at least one processor causes the at least one processor:

to determine multiple sub-regions of watermark addition regions of all frames of images in the video;

to determine binary expected play time information of a target image requiring watermark addition at present and a digit in the binary expected play time information corresponding to each sub-region, wherein the number of the sub-regions is not less than the number of digits in the binary expected play time information; and

to adjust the specific parameter value of each sub-region according to the binary expected play time information to make a parity value corresponding to the specific parameter value of each sub-region equal to the value of the digit of the binary expected play time information corresponding to the sub-region, so that a video display terminal determines the binary expected play time information of the target image according to the parity values corresponding to the specific parameter values of all sub-regions in the watermark addition regions of the target image.

In the third aspect, the embodiment of this application provides a non-transitory computer-readable storage medium storing executable instructions that, when executed by an electronic device with a touch-sensitive display, cause the electronic device:

to determine multiple sub-regions of watermark addition regions of all frames of images in the video;

to determine binary expected play time information of a target image requiring watermark addition at present and a digit in the binary expected play time information corresponding to each sub-region, wherein the number of the sub-regions is not less than the number of digits in the binary expected play time information; and

to adjust the specific parameter value of each sub-region according to the binary expected play time information to make a parity value corresponding to the specific parameter value of each sub-region equal to the value of the digit of the binary expected play time information corresponding to the sub-region, so that a video display terminal determines the binary expected play time information of the target image according to the parity values corresponding to the specific parameter values of all sub-regions in the watermark addition regions of the target image.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic diagram of a method for adding watermarks to a video in accordance with some embodiments.

FIG. 2 is a schematic diagram of a sub-region which is a macro block in accordance with some embodiments of this application;

FIG. 3 is a schematic diagram showing division of sub-regions in a watermark addition region in accordance with some embodiments of this application;

FIG. 4 is a schematic diagram of pixels contained in a macro block in accordance with some embodiments of this application;

FIG. 5 (a) is a schematic diagram showing sub-regions with the same scale in a watermark addition region in accordance with some embodiments of this application;

FIG. 5 (b) is a schematic diagram showing sub-regions with different scales in a watermark addition region in accordance with some embodiments of this application;

FIG. 6 is a schematic diagram showing adjusting in a watermark addition region according to binary expected play time information in accordance with some embodiments of this application;

FIG. 7 is a schematic diagram of a method for determining information of watermarks in accordance with some embodiments of this application;

FIG. 8 is a schematic diagram showing a whole process of a method for adding watermarks to a video and determining information of the watermarks in accordance with some embodiments of this application;

FIG. 9 is a schematic diagram showing the structure of equipment for adding watermarks to a video in accordance with some embodiments of this application;

FIG. 10 is a schematic diagram showing the structure of equipment for determining information of watermarks in accordance with some embodiments of this application;

FIG. 11 is a schematic diagram showing the structure of electronic device for adding watermarks to a video in accordance with some embodiments of this application; and

FIG. 12 is a schematic diagram showing the structure of another equipment for determining information of watermarks in accordance with some embodiments of this application.

### DETAILED DESCRIPTION

The embodiment of this application provides a method for adding watermarks to a video, including: determining multiple sub-regions of watermark addition regions of all frames of images in the video in the same way; determining binary expected play time information of a target image requiring watermark addition at present and a digit in the binary expected play time information corresponding to each sub-region, where the number of the sub-regions is not less than the number of digits in the binary expected play time information; and adjusting a specific parameter value of each sub-region according to the binary expected play time information to make a parity value corresponding to the specific parameter value of each sub-region equal to the value of the digit of the binary expected play time information corresponding to the sub-region, so that a video display terminal determines the binary expected play time information of the target image according to the parity values corresponding to the specific parameter values of all sub-regions in the watermark addition regions of the target image.

According to the method for adding watermarks, provided by the embodiment of this application, the parity values of the specific parameter values of sub-regions in watermark addition regions of an image to be added with a watermark can be adjusted according to expected play time information, and since there is a corresponding relationship between each sub-region and binary expected play time information, a decoding device can determine the binary expected play time information according to the parity values of all sub-regions of the image added with watermarks.

In order to make the objects, the technical solutions and the advantages of the embodiments of this application more clear, the technical solutions in the embodiments of this application will be described herein clearly and completely with reference of with reference to the accompanying drawings of the embodiments of this application. Obviously, these embodiments described herein are not all, but just part of the embodiments, rather than all of the embodiments of this application. Based pm on the embodiments in this application, all other embodiments obtained by those skilled in the art without making creative works belong to the protection scope of this application.

As shown in FIG. 1, the embodiment of this application provides a method for adding watermarks to a video, including:

Step 101, determining multiple sub-regions of watermark addition regions of all frames of images in the video, where each sub-region corresponds to a digit in binary expected play time information;

Step 102, determining binary expected play time information of a target image requiring watermark addition at present and a digit in the binary expected play time information corresponding to each sub-region, where the number of the sub-regions is not less than the number of digits in the binary expected play time information; and

Step 103, adjusting the specific parameter value of each sub-region according to the binary expected play time information to make a parity value corresponding to the specific parameter value of each sub-region equal to the value of the digit of the binary expected play time information corresponding to the sub-region, so that a video display terminal determines the binary expected play time information of the target image according to the parity values corresponding to the specific parameter values of all sub-regions in the watermark addition regions of the target image.

The method for adding watermarks, provided by the embodiment of this application, can be applied to a video coded according to H.264 standard and also to other videos adopting a coding way of generating other frames of images based on one frame of image. The H.264 standard is a popular coding and decoding standard. The executive body of the method for adding watermarks may be any equipment having a video coding function, such as a mobile phone and a computer.

In the embodiment of this application, binary expected play time information, i.e., a value obtained through converting the expected play time of one frame of image in an online video into a binary digit, is added to watermarks. A video player device can compare the expected play time information of one frame of image in the video with its actual play time so as to determine whether the video has latency or not and feed the determined latency information back to a server proving the video; and then the server will adjust network bandwidth according to the latency information so as to ameliorate the latency situation when the video player device is playing the video.

In practical application, the time represented by LSD (Least Significant Digit) of the binary expected play time information may be lms or other time (such as 0.1 ms). For example, if the expected play time information is 1000ms and the LSD of the binary expected play time information represents lms, then the converted binary expected play time information is 1111101000.

In the embodiment of this application, the watermark addition regions are image blocks with the same content in the video. The watermark addition regions may be LOGO (such as LOGO of a video provider) regions. If the video involves a program recorded by a TV station, the watermark addition regions also may be TV station LOGO regions. The positions and ranges of the watermark addition regions can be set in equipment for adding watermarks (such as a computer) according to the status of the video.

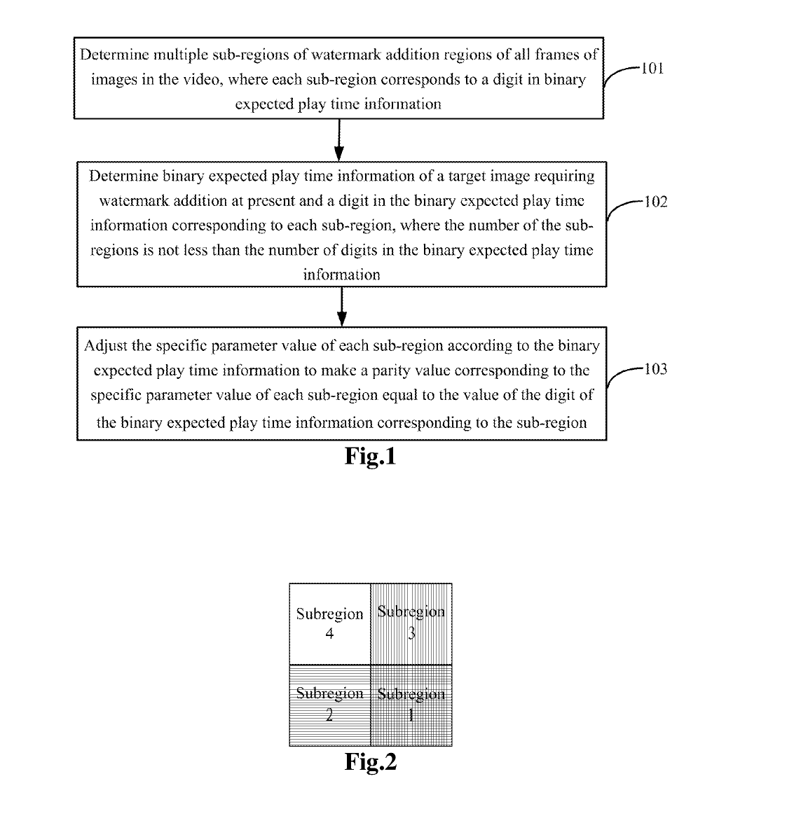

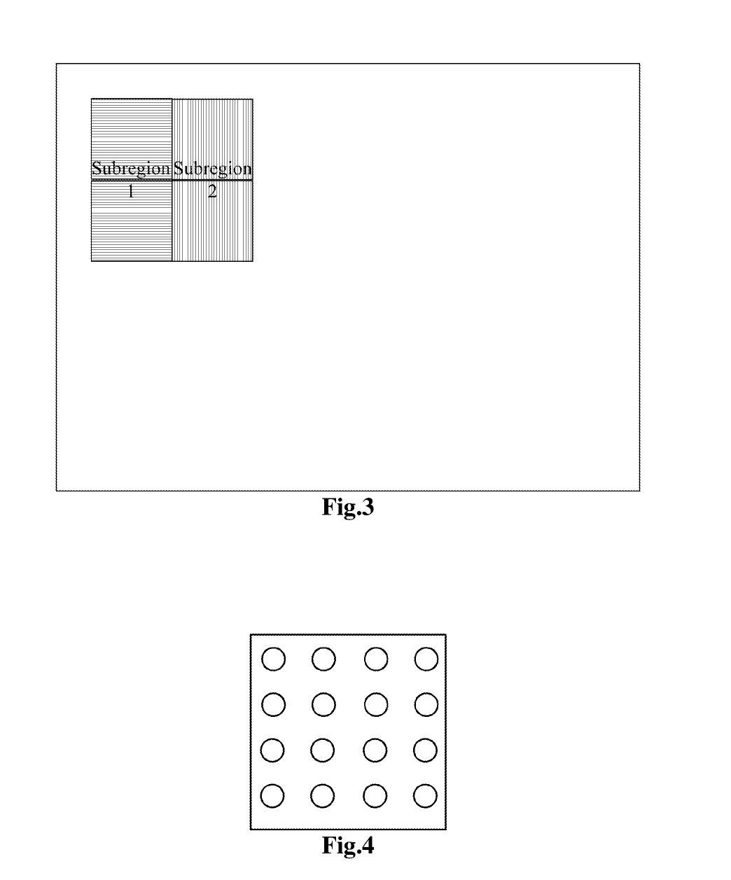

In the embodiment of this application, one or more macro blocks in the watermark addition regions are determined as sub-regions. According to H.264 standard, one frame of image consists of multiple macro blocks. The watermark addition regions are a part of one frame of image and also consist of multiple macro blocks. A macro block is an image block consisting of multiple pixels, single pixel cannot be adjusted directly during image adjusting, and the least unit adjusted every time is a macro block. One sub-region may be a ready-made macro block or may be divided in a watermark addition region and includes multiple macro blocks. As illustrated in FIG. 2, the water addition region of one frame of image consists of four macro blocks with the same scale and each of these macro blocks is taken as a sub-region. As shown in FIG. 3, the water addition region of one frame of image consists of four macro blocks with the same scale and is divided into two sub-regions (a left sub-region and a right sub-region) and each sub-region includes two macro blocks.

According to the number and arrangement of pixels, the macro blocks are divided into the five types: 4×4, 16×16, 8×16, 16×8 and 8×8. The macro blocks are square or rectangular matrixes consisting of pixels, figures in front of product signs represent the numbers of lateral pixels while figures behind product signs represent the numbers of vertical pixels, and the least marco block is of the type 4×4. For example, as shown in FIG. 4, one macro block is at a scale of 4×4. The same frame of image coded according to H.264 standard may adopt macro blocks with different scales. For example, a region with high image contrast adopts smaller macro blocks, whereas the region with low image contrast adopts larger macro blocks.

In the embodiment of this application, the sub-regions of water addition regions of all frames of images in the video are determined in the same way. For example, the watermark addition region of the first frame of image in the video is divided into four equal sub-regions and the watermark addition region of the second frame of image in the video is also divided into four equal sub-regions.

In practical application, all macro blocks or part of them in a watermark region may be selected to be added for determining sub-regions.

Optionally, a certain number of pure white or pure black macro blocks in a watermark addition region are taken as sub-regions while other macro blocks are not taken as sub-regions for adding binary expected play time. If such method is adopted, the number of pure white or pure black macro blocks should be more than or equal to the number of digits in binary expected play time information; otherwise, the abovementioned method in which any macro blocks are selected from the watermark addition region as sub-regions should be adopted.

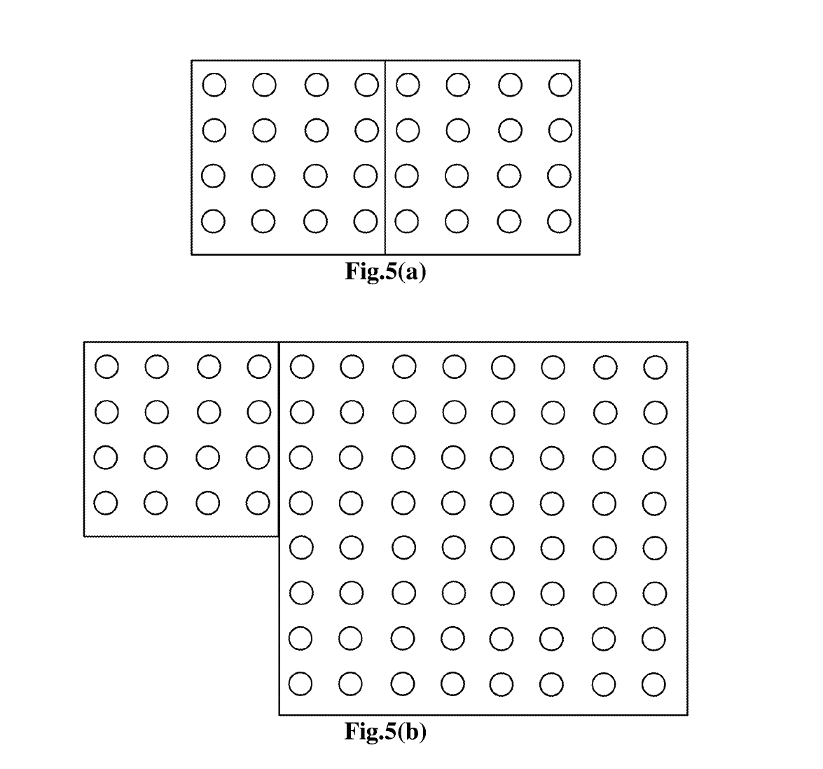

The scales of sub-regions contained in a watermark addition region may be the same or different. For example, as shown in FIG. 5 (a), a watermark addition region contains two sub-regions, each sub-region is a 4×4 macro block. In another example as shown in FIG. 5 (b), a watermark addition region contains two sub-regions: one of the two sub-regions is a 4×4 macro block and the other sub-region is an 8×8 macro block.

A corresponding relationship can be established between each sub-region in a watermark addition region and a digit in binary expected play time information. If there is a correspondence between one sub-region in a watermark addition region and a digit in the binary expected play time information, a specific parameter value of the sub-region of one frame of image can be adjusted according to the value of a digit in the binary expected play time information of this frame of image. The number of sub-regions should be more than or equal to the number of digits in the binary expected play time information.

If the number of the sub-regions is equal to the number of the digits in the binary expected play time information, the specific parameter value of a sub-region corresponding to each digit in the binary expected play time information is adjusted according to the value of each digit in the binary expected play time information. For example, a watermark addition region is divided into two sub-regions: a sub-region 1 and a sub-region 2. The binary expected play time information is a two-digit number 10. The sub-region 1 corresponds to the lower digit in the two-digit binary expected play time information while the sub-region 2 corresponds to the higher digit in the two-digit binary expected play time information. Then, the specific parameter value of the sub-region 2 is adjusted according to 1 and the specific parameter value of the sub-region 1 is adjusted according to 0.

If the number of the sub-regions is more than the number of the digits in the binary expected play time information, the specific parameter values of sub-regions, the specific parameter values of sub-regions having a correspondence with each digit in the binary expected play time information respectively are adjusted according to the value of each digit in the binary expected play time information and the specific parameter values of sub-regions not having a correspondence with each digit in the binary expected play time information are not changed. For example, a watermark addition region is divided into four sub-regions: a sub-region 1, a sub-region 2, a sub-region 3 and a sub-region 4. The binary expected play time information is a two-digit number 10. The sub-region 1 corresponds to the lower digit in the two-digit binary expected play time information while the sub-region 2 corresponds to the higher digit in the two-digit binary expected play time information. Then, the specific parameter value of the sub-region 2 is adjusted according to 1, the specific parameter value of the sub-region 1 is adjusted according to 0, and the original specific parameter values of the sub-regions 3 and 4 are kept unchanged.

The position of each sub-region in each frame of image and the correspondence between each sub-region and a digit in the binary expected play time information are preset in equipment for adding watermarks and equipment for reading the information of the watermarks and the two pieces of equipment have the same settings about the position of each sub-region in each frame of image and the correspondence between each sub-region and a digit in the binary expected play time information.

According to the method for adding watermarks, provided by the invention, the same image parameter value (i.e., the specific parameter value) of each sub-region is adjusted according to the binary expected play time information, where the specific parameter value may be one of a brightness value, a tone value, a color saturation value, a brightness residual, a tone residual, and a color saturation residual in a YUV coordinate system. According to H.264 standard, the brightness value ranges from 0 to 255 and the tone value and the color saturation value both range from 0-127 after coding. The brightness value with a larger range is more suitable to be used as the specific parameter value containing the added expected play time information. There are two types of methods for adjusting the specific parameter value of an image based on different specific parameter values:

Method 1, the specific parameter value is the parameter value of the image.

In such situation, the specific parameter value is one of a brightness value, a tone value and a color saturation value.

Specifically, taking the situation in which the specific parameter value is a brightness value and the region to be adjusted is a sub-region in a watermark addition region as an example, by adjusting, the parity value of brightness in the sub-region becomes equal to the value of one digit in the binary expected play time information, where the parity value of a sub-region is 1 when the brightness parameter values of all pixels in this sub-region are odd and the parity value of a sub-region is 0 when the brightness parameter values of all pixels in this sub-region are even; or the parity value of a sub-region is 0 when the brightness parameter values of all pixels in this sub-region are odd and the parity value of a sub-region is 1 when the brightness parameter values of all pixels in this sub-region are even.

Adjusting the brightness value of a sub-region according to a parity value can be implemented in two ways based on positive logic and negative logic:

(1) Positive Logic:

If a sub-region corresponds to 0 in the binary expected play time information, the brightness values of all pixels in this region can be adjusted to be odd; if a sub-region corresponds to 1 in the binary expected play time information, the brightness values of all pixels in this region can be adjusted to be even. For a coding device based on positive logic, binary coded information does not need to be processed.

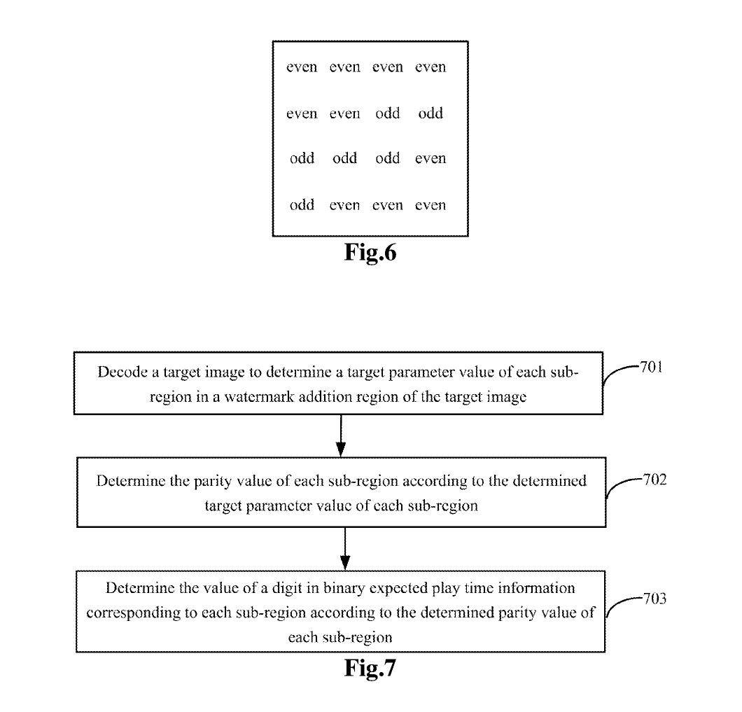

For example, there are two pixels in one sub-region, the brightness value of the pixel 1 is 2 and the brightness value of the pixel 2 is 3; in order to enable the sub-region to include information of 0, the brightness values of all pixels in the sub-region need to be adjusted to be even; therefore, the brightness value of the pixel 1 is not adjusted, the parameter value of the pixel 2 is added with 1; as a result, after such adjustment, the brightness value of the pixel 1 is 2 and the brightness value of the pixel 2 is 4, thus finally determining the parity value of the sub-region so as to obtain the parity value of 0. For example, as shown in FIG. 6, the brightness parameter value of a watermark addition region containing 4×4 sub-regions is adjusted according to binary expected play time information 001111101000, so as to determine the parity of the brightness values of all sub-regions in the watermark addition region, where if the brightness values of all pixels in on sub-region are odd, the parity of this region is “odd”; and if the brightness values of all pixels in on sub-region are even, the parity of this region is “even”.

(2) Negative Logic:

If a sub-region corresponds to 0 in the binary expected play time information, the brightness values of all pixels in this region can be adjusted to be odd; if a sub-region corresponds to 1 in the binary expected play time information, the brightness values of all pixels in this region can be adjusted to be even.

Negative logic is contrary to positive logic. 1 in positive logic represents an actual FIG. 1 while 1 in negative logic represents an actual figure 0. Through carrying out negation on the figure at each digit of a multi-digit binary negative logic figure, an actual figure can be obtained. For example, the negative logic figure “101” represents an actual figure 010. Negative logic is contrary to positive logic in parity as well. For example, 1 in negative logic is even while 0 is odd.

Therefore, if a coding device adopts negative logic, the coding device carries out negation by digit according to binary coded information and then adjusts the specific parameter value of a sub-region according to the binary coded information subjected to negation. Taking adjusting the brightness value of one pixel in negative logic as an example, the value of a digit, corresponding to this sub-region, in the binary expected play time information in negative logic is 1, and then the brightness value of the pixel is adjusted to be even; the negative logic brightness value of the pixel is 100, and then the brightness value can be adjusted to be 101.

In the embodiment of this application, after adjusting the specific parameter of one sub-region, the specific parameter values of all pixels in the sub-region will be the same in parity theoretically. However, data distortion may occur due to coding and decoding and it is possible that the parity values of the specific parameter values of several pixels in one sub-region are different from the parity values of the specific parameter values of most other pixels in the sub-region. Users can set a certain ratio in equipment for determining information of watermarks; if the odd specific parameter values of pixels in one sub-region is beyond a certain proportion (such as 80%), it is considered that the parity value of the specific parameter value of this sub-region is 1 (or 0); if the even specific parameter values of pixels in one sub-region is beyond a certain proportion (such as 80%), it is considered that the parity value of the specific parameter value of this sub-region is 0 (or 1). For example, there are 16 pixels in one sub-region. The brightness values of these 16 pixels are adjusted according to one digit in the binary expected play time information; after decoding, the obtained brightness values of 15 of these 16 pixels are even and the brightness value of one pixel is even; when user's setting determines the parity value of the brightness value of the sub-region, if the brightness values of 80% of pixels in the sub-region are the same in parity, the parity value of the whole sub-region can be determined according to the parity of this 80% of pixels and the parity value of this sub-region is 0.

Optionally, adjusting the parity value of the brightness value of one sub-region to be 1 includes:

if the brightness value of one pixel in the sub-region is odd, not adjusting the brightness value of the pixel; if the brightness value of one pixel in the sub-region is even, add 1 to the brightness value of the pixel;

adjusting the parity value of the brightness value of one sub-region to be 0 includes:

if the brightness value of one pixel in the sub-region is even, not adjusting the brightness value of the pixel; and if the brightness value of one pixel in the sub-region is odd, add 1 to the brightness value of the pixel;

In the Method 1, a coding device retains the content of all sub-regions of each frame of image in the video during coding. A decoding module of a video player device can directly take the brightness values (i.e., the specific parameter values) of all sub-regions of each frame of image before decoding as the brightness values (i.e., the target parameter values) of all sub-regions of each frame of image after decoding.

Method 2, the specific parameter value is residual of the parameter.

In such situation, the specific parameter value is one of brightness residual, tone residual and color saturation residual.

According to H.264 standard, a coding device can compress image blocks at the same position and with the same or similar content in multiple frames of images and retains the image block of one frame of image among them as a reference and also retains the difference between the image blocks of other frames of images and the image block of the frame of image functioning as a reference. When decoding a video coded in such way, a video player device can generate the image blocks of other frames of images according to the image block of the image functioning as a reference and the difference between the image blocks of other frames of images and the image block of this frame of image.

In the embodiment of this application, the specific parameter value is residual of one parameter, representing variation of one parameter between sub-regions at the same position in one frame of image (i.e., a target image) and an image (i.e., a reference image) functioning as the reference of this frame of image.

The contents of water addition regions of all frames of images are the same initially; therefore, the specification parameter values of all sub-regions of the target image under the initial state are 0 and also may be 1 if in negative logic.

Taking the situation that the specific parameter value is a brightness residual as an example, in the embodiment of this application, the specific parameter value is adjusted according to the binary expected play time information to make a parity value of the specific parameter value of one sub-region equal to the value of a digit, corresponding to this sub-region, in the binary expected play time information. The adjusting method will not be repeated herein since it is identical to the adjusting method adopted in the Method 1.

Optionally, the reference parameter value of each sub-region in the watermark addition region of the reference image is adjusted so that the reference parameter value of each sub-region is even;

where, adjusting the brightness value of one sub-region of the reference image to be odd includes:

if the brightness value of one pixel in the sub-region is odd, not adjusting the brightness value of the pixel; and if the brightness value of one pixel in the sub-region is even, add 1 to the brightness value of the pixel;

where, adjusting the brightness value of one sub-region of the reference image to be even includes:

if the brightness value of one pixel in the sub-region is even, not adjusting the brightness value of the pixel; and if the brightness value of one pixel in the sub-region is even, add 1 to the brightness value of the pixel;

After the aforesaid adjustment is performed, the reference parameter values of all pixels in each sub-region in the watermark addition region of the reference image are even. The video player device can sum the reference parameter value of one sub-region of the reference image and the specific parameter value of one sub-region at the same position in the target image, so as to obtain a target parameter value of this sub-region in the target image. Therefore, in the situation that all the reference parameter values are adjusted to be even, the parity of the target parameter values is identical to the parity of the specific parameter values. By adjusting the parity of the specific parameter value of one sub-region of the target image before coding, the parity of the target parameter value of this sub-region of the target image after coding can be controlled, i.e., the parity value of the specific parameter value and the parity value of the target parameter value corresponding to the same sub-region are equal.

In practical application, taking the situation that the reference parameter value is a brightness value and the specific parameter value is a brightness residual as an example, adjusting the brightness residual of one sub-region of the target image includes three steps:

Step 1, adjusting the brightness value of the reference image.

The brightness values of all pixels in the watermark addition region of the reference image are adjusted to be even or odd, and the adjusting method will not be repeated herein since it is identical to the method adopted in the Method 1 for adjusting the brightness values of all pixels in one sub-region to be even.

Optionally, if sub-regions are all white or black macro blocks selected from the watermark addition region, as described above, the Step 1 is not necessary. Because the brightness values of all pixels in the white macro blocks are 255 (the brightness values are all odd and the coding device adopts negative logic) while the brightness values of all pixels in the black macro blocks are 0 (the brightness values are all even and the coding device adopts positive logic), the Step 1 (i.e., adjusting the parameters of all pixels in the reference image to be even) is not necessary in the Method 2 due to adoption of such sub-region selection method.

Step 2, processing the binary expected play time information.

In the embodiment of this application, before adjusting the specific parameter value according to the binary expected play time information, the binary expected play time information is processed according to a reference image selection method, so as to obtain binary variation time information. The digits in the binary variation time information are in one-to-one correspondence with digits in the binary expected time information. For example, the binary expected play time information is of two digits; the most significant digit corresponds to the sub-region 2 and the least significant digit corresponds to the sub-region 1. The binary variation time information is of two digits too; the most significant digit corresponds to the sub-region 2 and the least significant digit corresponds to the sub-region 1.

In the embodiment of this application, according to the reference image selection method, there are two methods for determining the binary variation time information:

(1) The first frame of image of the video is taken as the reference image.

If the reference image is the first frame of image of the video, the binary expected play time information is taken as the binary variation time information.

(2) A frame of image previous to the target image is taken as the reference image.

An operation (such as XOR operation) can be carried out on the binary expected play time information corresponding to the frame of image previous to the target image and the binary expected play time information of the target image, so as to figure out which digits in the expected play time information of the target image have variation relative to expected play time information of the previous frame of image functioning as the reference image, and the operation result is taken as binary variation time information. For example, the reference image is the first frame of image of the video and the binary expected play time information is 1, and then the binary variation time information is 1. For another example, the reference image is the frame of image previous to the target image, the binary expected play time information of the target image is 11, and the binary expected play time information corresponding to the previous frame of image is 10, and then 11 and 10 have an XOR operation to obtain binary variation time information which is 1.

Step 3, adjusting the brightness residual of the target image.

The brightness residuals of all pixels in all residual blocks corresponding to sub-regions are determined according to the values of digits, corresponding to the sub-regions, in the binary variation time information. The way of controlling the residuals of sub-regions in H.264 standard is adjusting all values in all residual blocks corresponding to the sub-regions.

One residual block is fixed as a residual macro block containing 4×4 pixels and one sub-region may correspond to one or more residual blocks, which depends on the scale of the sub-region.

For example, one sub-region corresponds to a digit whose value is 1 in the binary variation time information, and the sub-region corresponds to four residual blocks each of which consists of 4×4 pixels, and then the total 16 residuals in these four residual blocks are set to be 1.

The method for adding watermark information, provided by the embodiment of this application, is associated with H.264 coding, and the coding mode may be set to some extent so as to reach the best effect.

Optionally, the quantization level of coding is adjusted and “quantization, variation, inverse quantization and inverse transformation” of coding are set as “lossless”. Therefore, it can be ensured to avoid the situation that the residuals of the specific parameters used for determining the expected play time information of images are lost in the coding and decoding process of all frames of images in the video.

Optionally, a macro block prediction mode for generating sub-regions of the target image is set to be “direct prediction” (i.e., P_10 mode). There are many prediction modes for generating image blocks of other frames of images through prediction according to the image blocks of the reference image in H.264 standard. Since the contents of watermark addition regions in all frames of images in the video used in the embodiment of this application are static, motion compensation is not necessary and the direct prediction mode for the residual of a specific parameter can be used.

Optionally, the prediction mode for determining sub-regions in the target image according to the residuals of the specific parameter values corresponding to the sub-regions is set to be P macro block prediction mode.

In the embodiment of this application, after equipment for adding watermarks adds watermarks to a video, the existing coding device can be used for coding the video added with watermarks, so as to obtain a coded video meeting H.264 standard.

As shown in FIG. 7, the embodiment of this application provides a method for determining information of watermarks in a video, including:

Step 701, decoding a target image to determine a target parameter value of each sub-region in a watermark addition region of the target image;

Step 702, determining the parity value of each sub-region according to the determined target parameter value of each sub-region; and

Step 703, determining the value of a digit in binary expected play time information corresponding to each sub-region according to the determined parity value of each sub-region;

where, the parity value of each sub-region is adjusted by a coding device according to the binary expected play time information;

where, the executive body of the method for determining information of watermarks may be a video player device or a server which can carry out communication with the video player device.

The embodiment of this application is used for determining the specific parameter values of all sub-regions in the decoded video after a decoding module (such as a decoder chip) of the video player device decodes the video added with watermarks. The sub-regions correspond to the sub-regions mentioned above in the method for adding watermarks.

If the video decoded by the decoding device is the video mentioned above in the Method 1 for adding watermarks, the decoding device can directly take the specific parameter values of each sub-region of the target image as the target parameter values of each sub-region of the target image; if the video decoded by the decoding device is the video mentioned above in the Method 2 for adding watermarks, the decoding device can sum the reference parameter value of each sub-region of the reference image and the specific parameter value of each sub-region of the target image, so as to obtain the target parameter value of each sub-region of the target image.

In the embodiment of this application, after the target parameter value of each sub-region is obtained, the value of a digit in the binary expected play time information corresponding to each sub-region can be determined through determining the parity value of the target parameter value of each sub-region, where once the parity value of one sub-region is determined, the parity of the target parameter values of all pixels in this sub-region is determined. The correspondence between the parity value of one sub-region and the parity of all pixels in this sub-region has been described in detail in the abovementioned method for adding watermarks and it will be not repeated herein.

After the binary expected play time information is determined, the binary expected play time can be quantized and multiplied by time represented by the least significant digit, so as to obtain expected time information. For example, after the binary expected play time information 11_1110_1000 is obtained, the binary expected play time information is multiplied by time lms represented by the least significant digit, so as to obtain expected time information 1000 ms of the target image.

According to the method for determining information of watermarks, provided by the embodiment of this application, since the value of a digit in the binary expected time information can be obtained through determining the parity value of the target parameter of one sub-region of one frame of image, the binary expected play time information of one frame of image according to the parity values of the target parameters of all sub-regions of this frame of image.

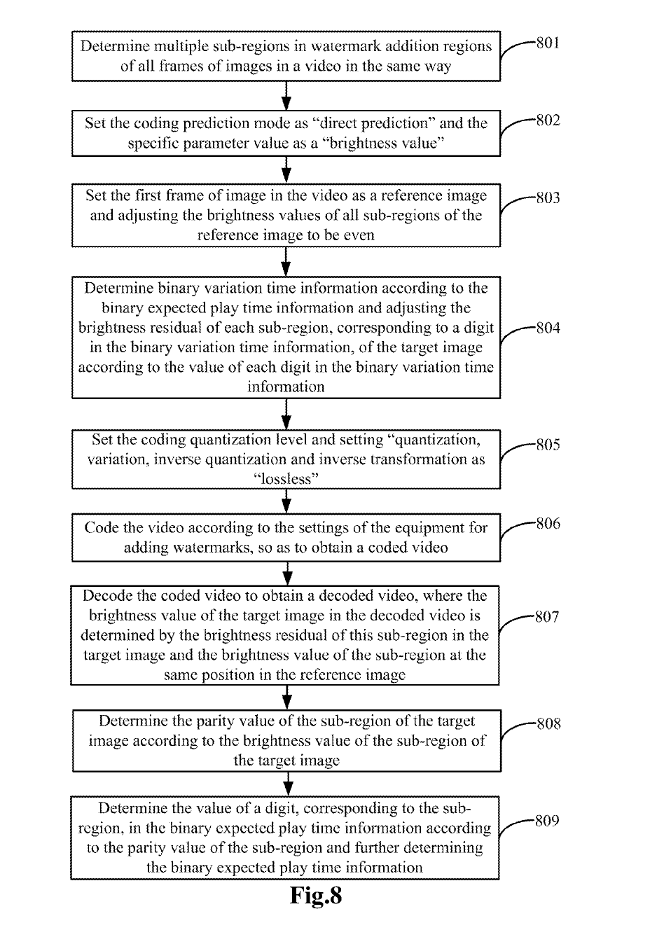

As shown in FIG. 8, a whole process of a method for adding watermarks to a video and determining information of the watermarks in the embodiment of this application includes:

where Step 804 provides a method for adjusting the residual of the specific parameter value of one sub-region according to a digit in the binary expected time information and the method will be executed many times in this process until the residuals of the specific parameter values of all sub-region in the watermark addition region according to the whole binary expected time information. Similarly, Steps 805-807 provide a method for determining a digit in the binary expected play time information according to the target parameter of one sub-region and the method will be executed many times so as to determine the whole binary expected play time information according to the target parameters of all sub-regions.

Step 801, determining, by equipment for adding watermarks, multiple sub-regions in watermark addition regions of all frames of images in a video in the same way;

Step 802, setting, by the equipment for adding watermarks, the coding prediction mode as “direct prediction” and the specific parameter value as a “brightness value”;

Step 803, setting, by the equipment for adding watermarks, the first frame of image in the video as a reference image and adjusting the brightness values of all sub-regions of the reference image to be even;

Step 804, determining, by the equipment for adding watermarks, binary variation time information according to the binary expected play time information and adjusting the brightness residual of each sub-region, corresponding to a digit in the binary variation time information, of the target image according to the value of each digit in the binary variation time information;

Step 805, setting, by the equipment for adding watermarks, the coding quantization level and setting “quantization, variation, inverse quantization and inverse transformation as “lossless”;

Step 806, coding the video by a coding device according to the settings of the equipment for adding watermarks, so as to obtain a coded video;

Step 807, decoding the coded video by a decoding device to obtain a decoded video, where the brightness value of the target image in the decoded video is determined by the brightness residual of this sub-region in the target image and the brightness value of the sub-region at the same position in the reference image;

Step 808, determining the parity value of the sub-region of the target image by equipment for determining information of watermarks according to the brightness value of the sub-region of the target image; and

Step 809, determining, by the equipment for determining information of watermarks, the value of a digit, corresponding to the sub-region, in the binary expected play time information according to the parity value of the sub-region and further determining the binary expected play time information.

According to the method for adding watermarks, provided by the embodiment of this application, the parity values of the specific parameter values of sub-regions in watermark addition regions of an image to be added with watermarks can be adjusted according to the expected play time information, and since there is a correspondence between each sub-region and the binary expected play time information, the decoding device can determine the binary expected play time information according to the parity values of all sub-regions of the image added with watermarks. In addition, through determining the parity value of the target parameter of one sub-region of one frame of image, the value of a digit in the binary expected play time information can be obtained and therefore the binary expected play time information of one frame of image can be obtained according to the parity values of the target parameters of all sub-regions of this frame of image.

Based on the same invention concept, the embodiment of this application further provides equipment for adding watermarks to a video. Since a method corresponding to the equipment is the method disclosed by the embodiment of this application and the principle of the solution According to the method is similar to that of the method disclosed by the embodiment of this application, the implementation of the equipment may refer to the implementation of the method and it will not be repeated herein.

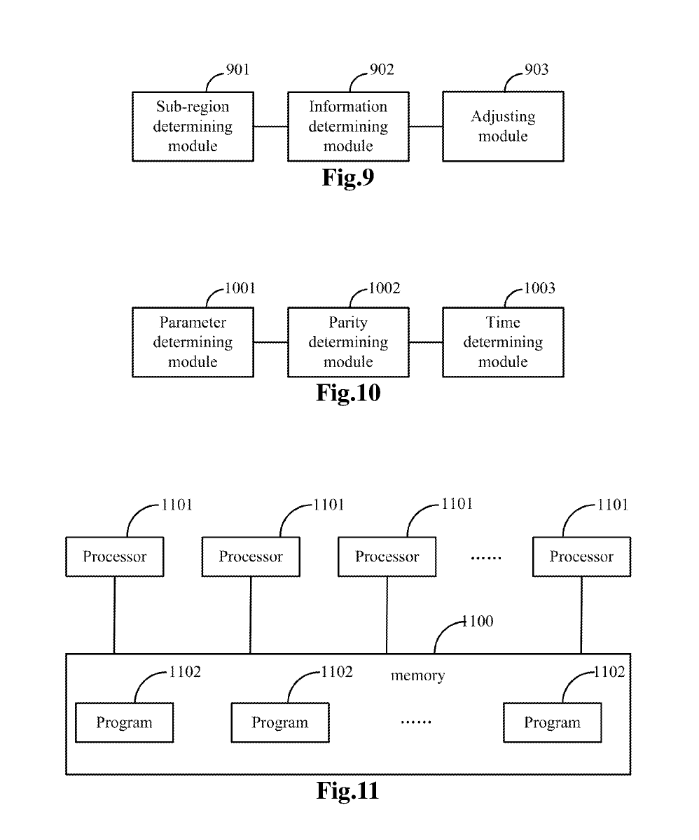

As shown in FIG. 9, the embodiment of this application provides equipment for adding watermarks in a video, including:

a sub-region determining module 901 is configured to determine multiple sub-regions of watermark addition regions of all frames of images in the video;

an information determining module 902 is configured to determine binary expected play time information of a target image requiring watermark addition at present and a digit in the binary expected play time information corresponding to each sub-region, where the number of the sub-regions is not less than the number of digits in the binary expected play time information; and

an adjusting module 903is configured to adjust the specific parameter value of each sub-region according to the binary expected play time information to make a parity value corresponding to the specific parameter value of each sub-region equal to the value of the digit of the binary expected play time information corresponding to the sub-region, so that a video display terminal determines the binary expected play time information of the target image according to the parity values corresponding to the specific parameter values of all sub-regions in the watermark addition regions of the target image.

Optionally, the adjusting module 903 is specifically configured:

to determine binary variation time information according to the binary expected play time information;

to determine a digit in the binary variation time information corresponding to each sub-region according to a correspondence between the sub-regions and digits in the binary variation time information;

and to take the values of the digits in the binary variation time information as the specific parameter values of the corresponding sub-regions.

Optionally, the specific parameter value is determined according to the target image and the reference image;

The information determining module 902 is specifically configured:

if the reference image is the first frame of image of the video, to take the binary expected play time information as binary variation time information; and

if the reference image is a frame of image previous to the target image in the video, to convert reference time information of the frame of image previous to the target image into binary reference time information and then determining the binary variation time information according to the binary expected play time information and the binary reference time information, where the binary reference time information of the previous frame of image is the expected play time information of the frame of image.

Optionally, the specific parameter value is one of the following parameters:

a brightness value, a tone value, a color saturation value, a brightness residual, a tone residual, and a color saturation residual.

Optionally, the specific parameter value is one of brightness residual, tone residual, and color saturation residual.

The adjusting module 903 is further configured:

to adjust the reference parameter value of each sub-region in the watermark addition region of the reference image so that the reference parameter value of each sub-region is even;

where, if the reference parameter value is a brightness value, the specific parameter is a brightness residual; if the reference parameter value is a tone value, the specific parameter is a tone residual; and if the reference parameter value is a color saturation value, the specific parameter is a color saturation residual.

According to the method for adding watermarks, provided by the embodiment of this application, the parity values of the specific parameter values of sub-regions in watermark addition regions of an image to be added with watermarks can be adjusted according to expected play time information, and since there is a correspondence between each sub-region and binary expected play time information, a decoding device can determine the binary expected play time information according to the parity values of all sub-regions of the image added with watermarks.

As shown in FIG. 10, the embodiment of this application provides equipment for determining information of watermarks in a video, including:

a parameter determining module 1001 is configured to determine the target parameter value of each sub-region according to the specific parameter value of each sub-region in a watermark addition region of a target image;

a parity determining module 1002 is configured to determine the parity value of the target parameter value of each sub-region; and

a time determining module 1003 is configured to determine the value of a digit in binary expected play time information corresponding to each sub-region according to the determined parity value of the target parameter value of each sub-region;

where, the parity value of the specific parameter value of each sub-region is adjusted by a coding device according to the binary expected play time information; the parity values of the specific parameter value and the target parameter value of the same sub-region are equal.

Optionally, the parity determining module 1002 is specifically configured:

to determine the parity value of the target parameter value of each sub-region according to the target parameter value of each sub-region in a watermark region of a target image;

where, if the target parameter value of a sub-region is odd, the parity value of the target parameter value of the sub-region is 1; and if the target parameter value of a sub-region is even, the parity value of the target parameter value of the sub-region is 0; or

if the target parameter value of a sub-region is odd, the parity value of the target parameter value of the sub-region is 0; and if the target parameter value of a sub-region is even, the parity value of the target parameter value of the sub-region is 1.

Optionally, the time determining module 1003 is specifically configured:

to determine a digit in the binary variation time information corresponding to each sub-region according to a correspondence between the sub-regions and digits in the binary variation time information; and

to determine the value of the digit in the binary expected play time information corresponding to each sub-region according to the determined parity value of the target parameter value of each sub-region.

Optionally, the parameter determining module 1001 is specifically configured:

if the specific parameter value is one of a brightness value, a tone value and a color saturation value, to take the specific parameter value as the target parameter value of the sub-region; and

if the specific parameter value is one of brightness residual, tone residual and color saturation residual, for one sub-region of the target image, to determine the target parameter value of the sub-region of the target image according to the specific parameter value and the reference parameter value of the sub-region,

where, if the reference parameter value is a brightness value, the specific parameter is a brightness residual; if the reference parameter value is a tone value, the specific parameter is a tone residual; and if the reference parameter value is a color saturation value, the specific parameter is a color saturation residual.

Optionally, the target parameter value is one of the following parameters:

a brightness value, a tone value and a color saturation value.

According to the method for determining information of watermarks, provided by the embodiment of this application, since the value of a digit in the binary expected time information can be obtained through determining the parity value of the target parameter of one sub-region of one frame of image, the binary expected play time information of one frame of image can be obtained according to the parity values of the target parameters of all sub-regions of this frame of image.

As shown in FIG. 11, the embodiment of this application provides an electronic device for adding watermarks to a video, including a storage 1100, one or more processors 1101 and one or more programs 1102 storing instructions, where the one or more programs storing instructions, when operated by the one or more processors cause the at least one processor:

to determine multiple sub-regions of watermark addition regions of all frames of images in the video; to determine binary expected play time information of a target image requiring watermark addition at present and a digit in the binary expected play time information corresponding to each sub-region, where the number of the sub-regions is not less than the number of digits in the binary expected play time information; and to adjust the specific parameter value of each sub-region according to the binary expected play time information to make a parity value corresponding to the specific parameter value of each sub-region equal to the value of the digit of the binary expected play time information corresponding to the sub-region, so that a video display terminal determines the binary expected play time information of the target image according to the parity values corresponding to the specific parameter values of all sub-regions in the watermark addition regions of the target image.

Wherein execution of the instructions by the at least one processor causes the at least one processor to adjust the specific parameter value of each sub-region of the target image according to the expected play time information of the target image requiring watermark addition at present, further causes the at least one processor:

to determine binary variation time information according to the binary expected play time information; to determine a digit in the binary variation time information corresponding to each sub-region according to a correspondence between the sub-regions and digits in the binary variation time information; and to take the values of the digits in the binary variation time information as the specific parameter values of the corresponding sub-regions.

Wherein, specific parameter value is determined according to the target image and the reference image; and execution of the instructions by the at least one processor causes the at least one processor to determine binary variation time information according to the binary expected play time information, further causes the at least one processor:

when the reference image is the first frame of image of the video, to take the binary expected play time information as binary variation time information; or when the reference image is a frame of image previous to the target image in the video, to convert reference time information of the frame of image previous to the target image into binary reference time information and then to determine the binary variation time information according to the binary expected play time information and the binary reference time information, wherein the binary reference time information of the previous frame of image is the expected play time information of the frame of image.

Wherein the specific parameter value is one of the following parameters: a brightness value, a tone value, a color saturation value, a brightness residual, a tone residual, and a color saturation residual. wherein the specific parameter value is one of a brightness residual, a tone residual, and a color saturation residual; and execution of the instructions by the at least one processor further causes the at least one processor:

to adjust the reference parameter value of each sub-region in the watermark addition region of the reference image, so that the reference parameter value of each sub-region is even; wherein when the reference parameter value is a brightness value, the specific parameter is a brightness residual; when the reference parameter value is a tone value, the specific parameter is a tone residual; and when the reference parameter value is a color saturation value, the specific parameter is a color saturation residual.

The embodiment of this application provides a non-transitory computer-readable storage medium storing executable instructions that, when executed by an electronic device with a touch-sensitive display, cause the electronic device: to determine multiple sub-regions of watermark addition regions of all frames of images in the video;

to determine binary expected play time information of a target image requiring watermark addition at present and a digit in the binary expected play time information corresponding to each sub-region, wherein the number of the sub-regions is not less than the number of digits in the binary expected play time information; and

to adjust the specific parameter value of each sub-region according to the binary expected play time information to make a parity value corresponding to the specific parameter value of each sub-region equal to the value of the digit of the binary expected play time information corresponding to the sub-region, so that a video display terminal determines the binary expected play time information of the target image according to the parity values corresponding to the specific parameter values of all sub-regions in the watermark addition regions of the target image.

Wherein execution of the instructions by the electronic device causes the electronic device to adjust the specific parameter value of each sub-region of the target image according to the expected play time information of the target image requiring watermark addition at present, further causes the electronic device: to determine binary variation time information according to the binary expected play time information; to determine a digit in the binary variation time information corresponding to each sub-region according to a correspondence between the sub-regions and digits in the binary variation time information; and to take the values of the digits in the binary variation time information as the specific parameter values of the corresponding sub-regions.

Wherein specific parameter value is determined according to the target image and the reference image; and execution of the instructions by the electronic device causes the electronic device to determine binary variation time information according to the binary expected play time information, further causes the electronic device: when the reference image is the first frame of image of the video, to take the binary expected play time information as binary variation time information; or when the reference image is a frame of image previous to the target image in the video, to convert reference time information of the frame of image previous to the target image into binary reference time information and then to determine the binary variation time information according to the binary expected play time information and the binary reference time information, wherein the binary reference time information of the previous frame of image is the expected play time information of the frame of image.

Wherein the specific parameter value is one of the following parameters: a brightness value, a tone value, a color saturation value, a brightness residual, a tone residual, and a color saturation residual. wherein the specific parameter value is one of a brightness residual, a tone residual, and a color saturation residual; and execution of the instructions by the electronic device further causes the electronic device: to adjust the reference parameter value of each sub-region in the watermark addition region of the reference image, so that the reference parameter value of each sub-region is even; wherein when the reference parameter value is a brightness value, the specific parameter is a brightness residual; when the reference parameter value is a tone value, the specific parameter is a tone residual; and when the reference parameter value is a color saturation value, the specific parameter is a color saturation residual.

According to the method for adding watermarks, provided by the embodiment of this application, the parity values corresponding to the specific parameter values of sub-regions in watermark addition regions of an image to be added with watermarks can be adjusted according to expected play time information, and since there is a correspondence between each sub-region and binary expected play time information, a decoding device determines the binary expected play time information according to the parity values of all sub-regions of the image added with watermarks.

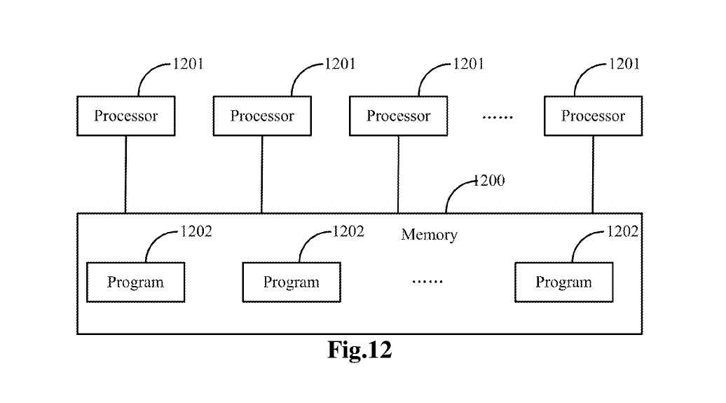

As shown in FIG. 12, the embodiment of this application provides another equipment for determining information of watermarks in a video, including:

a storage 1200, one or more processors 1201 and one or more programs 1202, where the one or more programs, when operated by the one or more processors, carry out the following operations:

determining the target parameter value of each sub-region according to the specific parameter value of each sub-region in a watermark addition region of a target image; determining the parity value of the target parameter value of each sub-region; and determining the value of a digit in binary expected play time information corresponding to each sub-region according to the determined parity value of the target parameter value of each sub-region;

where, the parity value of the specific parameter value of each sub-region is adjusted by a coding device according to the binary expected play time information; the parity values of the specific parameter value and the target parameter value of the same sub-region are equal.

According to the method for determining information of watermarks, provided by the embodiment of this application, since the value of a digit in the binary expected time information can be obtained through determining the parity value of the target parameter of one sub-region of one frame of image, the binary expected play time information of one frame of image can be obtained according to the parity values of the target parameters of all sub-regions of this frame of image.

The electronic device according to some embodiments of the disclosure can be in multiple forms, which include but not limit to:

1. Mobile communication device, of which characteristic has mobile communication function, and briefly acts to provide voice and data communication. These terminals include smart pone (i.e. iPhone), multimedia mobile phone, feature phone, cheap phone and etc.

2. Ultra mobile personal computing device, which belongs to personal computer, and has function of calculation and process, and has mobile networking function in general. These terminals include PDA, MID, UMPC (Ultra Mobile Personal Computer) and etc.

3. Portable entertainment equipment, which can display and play multimedia contents. These equipments include audio player, video player (e.g. iPod), handheld game player, electronic book, hobby robot and portable vehicle navigation device.

4. Server, which provides computing services, and includes processor, hard disk, memory, system bus and etc. The framework of the server is similar to the framework of universal computer, however, there is a higher requirement for processing capacity, stability, reliability, safety, expandability, manageability and etc due to supply of high reliability services.

5. Other electronic devices having data interaction function.

The embodiments of the apparatuses described above are merely exemplary, where the units described as separate components may or may not be physically separate, and the components illustrated as elements may or may not be physical units, that is, they can be collocated or can be distributed onto a number of network elements. A part or all of the modules can be selected as needed in reality for the purpose of the solution according to the embodiments of the disclosure.

The embodiments of the devices described above are only exemplary, in which the elements explained as separated parts may be or may not be separated physically and in which parts displayed as elements may be or may not be physical parts, i.e., they may be placed in one place or may be distributed on multiple network elements. The objects of this embodiment solution can be achieved by selecting the modules in part or in whole according to actual needs. It can be understood and implemented by those skilled in the art without paying creative labor.

Based on the descriptions of the abovementioned embodiments, it should be clearly understood by those skilled in the art that all the embodiments will be implemented via combination of software and a universal hardware platform and by hardware certainly. Based on such understanding, the aforesaid technical solution essentially or its part making a contribution to the prior art can be embodied in the form of software products and such computer software products may be stored in a computer readable storage medium, such as an ROM/RAM, a diskette and a light disk, and contain several instructions for enabling one set of computer equipment, which may be a PC, a server or network equipment, to execute the method described in each embodiment or in some part of the embodiments.

At last, it should be noted that the abovementioned embodiments are only used for illustrating but not limiting the technical solutions of this application. While this application has been described in detail herein with reference to the abovementioned embodiments, it should be understood by those skilled in art that they still may make changes to the technical solutions described in the embodiments or take equivalent replacements to part of technical features therein. These changes or replacements will not essentially depart the corresponding technical solutions from the spirit and scope of the technical solutions in all embodiments of this application.

What is claimed is:

1. A method for adding watermarks to a video, comprising:
determining, by an electronic device, multiple sub-regions of watermark addition regions of all frames of images in the video;
determining, by the electronic device, binary expected play time information of a target image requiring watermark addition at present and a digit in the binary expected play time information corresponding to each sub-region, wherein the number of the sub-regions is not less than the number of digits in the binary expected play time information; and
adjusting, by the electronic device, the specific parameter value of each sub-region according to the binary expected play time information to make a parity value corresponding to the specific parameter value of each sub-region equal to the value of the digit of the binary expected play time information corresponding to the sub-region, so that a video display terminal determines the binary expected play time information of the target image according to the parity values corresponding to the specific parameter values of all sub-regions in the watermark addition regions of the target image.

2. The method according to claim 1, wherein adjusting, by the electronic device, the specific parameter value of each sub-region of the target image according to the expected play time information of the target image requiring watermark addition at present comprises:
determining, by the electronic device, binary variation time information according to the binary expected play time information;
determining, by the electronic device, a digit in the binary variation time information corresponding to each sub-region according to a correspondence between the sub-regions and digits in the binary variation time information; and
taking, by the electronic device, the values of the digits in the binary variation time information as the specific parameter values of the corresponding sub-regions.

3. The method according to claim 2, wherein the specific parameter value is determined according to the target image and the reference image;
determining, by the electronic device, binary variation time information according to the binary expected play time information comprises:
when the reference image is the first frame of image of the video, taking, by the electronic device, the binary expected play time information as binary variation time information; or when the reference image is a frame of image previous to the target image in the video, converting, by the electronic device, reference time information of the frame of image previous to the target image into binary reference time information and then determining the binary variation time information according to the binary expected play time information and the binary reference time information, wherein the binary reference time information of the previous frame of image is the expected play time information of the frame of image.

4. The method according to claim 1, wherein the specific parameter value is one of the following parameters:
a brightness value, a tone value, a color saturation value, a brightness residual, a tone residual, and a color saturation residual.

5. The method according to claim 4, wherein the specific parameter value is one of a brightness residual, a tone residual, and a color saturation residual; and
adjusting, by the electronic device, the reference parameter value of each sub-region in the watermark addition region of the reference image, so that the reference parameter value of each sub-region is even;
wherein when the reference parameter value is a brightness value, the specific parameter is a brightness residual; when the reference parameter value is a tone value, the specific parameter is a tone residual; and when the reference parameter value is a color saturation value, the specific parameter is a color saturation residual.

6. An electronic device, comprising:
at least one processor; and
a memory communicably connected with the at least one processor for storing instructions executable by the at least one processor, wherein execution of the instructions by the at least one processor causes the at least one processor:
to determine multiple sub-regions of watermark addition regions of all frames of images in the video;
to determine binary expected play time information of a target image requiring watermark addition at present and a digit in the binary expected play time information corresponding to each sub-region, wherein the number of the sub-regions is not less than the number of digits in the binary expected play time information; and
to adjust the specific parameter value of each sub-region according to the binary expected play time information to make a parity value corresponding to the specific parameter value of each sub-region equal to the value of the digit of the binary expected play time information corresponding to the sub-region, so that a video display terminal determines the binary expected play time information of the target image according to the parity values corresponding to the specific parameter values of all sub-regions in the watermark addition regions of the target image.

7. The electronic device according to claim 6, wherein execution of the instructions by the at least one processor causes the at least one processor to adjust the specific parameter value of each sub-region of the target image according to the expected play time information of the target image requiring watermark addition at present, further causes the at least one processor:
to determine binary variation time information according to the binary expected play time information;
to determine a digit in the binary variation time information corresponding to each sub-region according to a correspondence between the sub-regions and digits in the binary variation time information; and
to take the values of the digits in the binary variation time information as the specific parameter values of the corresponding sub-regions.

8. the electronic device according to claim 7, wherein specific parameter value is determined according to the target image and the reference image; and
execution of the instructions by the at least one processor causes the at least one processor to determine binary variation time information according to the binary expected play time information, further causes the at least one processor:
when the reference image is the first frame of image of the video, to take the binary expected play time information as binary variation time information; or
when the reference image is a frame of image previous to the target image in the video, to convert reference time information of the frame of image previous to the target image into binary reference time information and then to determine the binary variation time information according to the binary expected play time information and the binary reference time information, wherein the binary reference time information of the previous frame of image is the expected play time information of the frame of image.

9. The electronic device according to claim 6, wherein the specific parameter value is one of the following parameters:
a brightness value, a tone value, a color saturation value, a brightness residual, a tone residual, and a color saturation residual.

10. The electronic device according to claim 9, wherein the specific parameter value is one of a brightness residual, a tone residual, and a color saturation residual; and
execution of the instructions by the at least one processor further causes the at least one processor:
to adjust the reference parameter value of each sub-region in the watermark addition region of the reference image, so that the reference parameter value of each sub-region is even;
wherein when the reference parameter value is a brightness value, the specific parameter is a brightness residual; when the reference parameter value is a tone value, the specific parameter is a tone residual; and when the reference parameter value is a color saturation value, the specific parameter is a color saturation residual.

11. A non-transitory computer-readable storage medium storing executable instructions that, when executed by an electronic device with a touch-sensitive display, cause the electronic device:
to determine multiple sub-regions of watermark addition regions of all frames of images in the video;
to determine binary expected play time information of a target image requiring watermark addition at present and a digit in the binary expected play time information corresponding to each sub-region, wherein the number of the sub-regions is not less than the number of digits in the binary expected play time information; and
to adjust the specific parameter value of each sub-region according to the binary expected play time information to make a parity value corresponding to the specific parameter value of each sub-region equal to the value of the digit of the binary expected play time information corresponding to the sub-region, so that a video display terminal determines the binary expected play time information of the target image according to the parity values corresponding to the specific parameter values of all sub-regions in the watermark addition regions of the target image.

12. The storage medium according to claim 11, wherein execution of the instructions by the electronic device causes the electronic device to adjust the specific parameter value of each sub-region of the target image according to the expected play time information of the target image requiring watermark addition at present, further causes the electronic device:
to determine binary variation time information according to the binary expected play time information;
to determine a digit in the binary variation time information corresponding to each sub-region according to a correspondence between the sub-regions and digits in the binary variation time information; and
to take the values of the digits in the binary variation time information as the specific parameter values of the corresponding sub-regions.

13. The storage medium according to claim 12, wherein specific parameter value is determined according to the target image and the reference image; and,
execution of the instructions by the electronic device causes the electronic device to determine binary variation time information according to the binary expected play time information, further causes the electronic device:
when the reference image is the first frame of image of the video, to take the binary expected play time information as binary variation time information; or
when the reference image is a frame of image previous to the target image in the video, to convert reference time information of the frame of image previous to the target image into binary reference time information and then to determine the binary variation time information according to the binary expected play time information and the binary reference time information, wherein the binary reference time information of the previous frame of image is the expected play time information of the frame of image.

14. The storage medium according to claim 11, wherein the specific parameter value is one of the following parameters:
a brightness value, a tone value, a color saturation value, a brightness residual, a tone residual, and a color saturation residual.

15. The storage medium according to claim 14, wherein the specific parameter value is one of a brightness residual, a tone residual, and a color saturation residual; and
execution of the instructions by the electronic device further causes the electronic device:
to adjust the reference parameter value of each sub-region in the watermark addition region of the reference image, so that the reference parameter value of each sub-region is even;
wherein when the reference parameter value is a brightness value, the specific parameter is a brightness residual; when the reference parameter value is a tone value, the specific parameter is a tone residual; and when the reference parameter value is a color saturation value, the specific parameter is a color saturation residual.
